(19) United States
(12) Patent Application Publication
(10) Pub. No.: US 2015/0366365 A1
(43) Pub. Date: Dec. 24, 2015

(54) Active Thermal Mattress

(71) Applicants: Michael A. Golin, Atlanta, GA (US); Michael S. DeFranks, Atlanta, GA (US)

(72) Inventors: Michael A. Golin, Atlanta, GA (US); Michael S. DeFranks, Atlanta, GA (US)

(21) Appl. No.: 14/745,739

(22) Filed: Jun. 22, 2015

Related U.S. Application Data
(60) Provisional application No. 62/015,723, filed on Jun. 23, 2014.

(51) Int. Cl. A47C 21/04; G05D 23/19

(52) U.S. Cl. CPC A47C 21/044; A47C 21/048; G05D 23/1928

(57) ABSTRACT

An active thermal mattress assembly having a plurality of sensors disposed within the active thermal mattress assembly, wherein at least one of the plurality of sensors monitors a surface temperature of the active thermal mattress assembly. The active thermal mattress assembly also including a temperature control system disposed within the active thermal mattress assembly and a processor disposed within the active thermal mattress assembly. The processor receives signals from each of the plurality of sensors and responsively controls an operation of the temperature control system to maintain an ideal surface temperature of the active thermal mattress assembly.

### CROSS-REFERENCE TO RELATED APPLICATIONS

This application claims the benefit of U.S. Application No. 62/015,723, filed Jun. 23, 2014, which is incorporated herein by reference in its entirety.

### BACKGROUND

The present disclosure generally relates to an active thermal mattress assembly and more particularly to an active thermal mattress assembly with body sensing.

Body temperature is a critical factor for restful sleep. The body prefers that its internal temperature drop slightly in order to fall asleep initially, and this temperature needs to be maintained within a certain range in order to achieve and maintain deep phases of sleep. For example, a bed situated within a hot, poorly-ventilated environment can be uncomfortable to the occupant and make it difficult to achieve desired rest. The user is more likely to stay awake or only achieve disruptive, uneven rest. Furthermore, even with normal air-conditioning, on a hot day, the bed occupant's back and other pressure points may remain sweaty while lying down. In the winter time, it is highly desirable to have the ability to quickly warm the bed of the occupant to facilitate the occupant's comfort, especially where heating units are unlikely to warm the indoor space as quickly. However, if the body temperature is regulated, he or she can fall asleep and stay asleep longer. Sleep quality and microclimate temperature are inexorably linked. There are several peer-reviewed research papers linking body surface temperature to quality of sleep.

Currently available heating and cooling sleep products, such as electric blankets, are static in nature and include user controlled interfaces that require the user to manually change the heating and cooling settings. One drawback of such systems is that they require the user to wake from sleep in order to adjust the heating and cooling settings. As a result, these products, although designed to improve sleep temperature comfort, can be disruptive to sleep. Therefore, a need exists to provide an active thermal mattress assembly with body sensing.

### BRIEF SUMMARY

Embodiments include an active thermal mattress assembly having a plurality of sensors disposed within the active thermal mattress assembly, wherein at least one of the plurality of sensors monitors a surface temperature of the active thermal mattress assembly. The active thermal mattress assembly also including a temperature control system disposed within the active thermal mattress assembly and a processor, which may be disposed within the active thermal mattress assembly. The processor receives signals from each of the plurality of sensors and responsively controls an operation of the temperature control system to maintain an ideal surface temperature of the active thermal mattress assembly.

Embodiments also include a method of improving a quality of sleep of a user of an active thermal mattress assembly. The method includes monitoring, by a processor, one or more temperature signals received from one or more sensors indicative of a surface temperature of one or more regions of the active thermal mattress assembly. The method also includes determining whether the surface temperature of the one, or more regions of the active thermal mattress assembly are within a threshold of an ideal temperature for the one or more regions of the active thermal mattress assembly. Based on determining that the surface temperature of at least one of the one or more regions of the active thermal mattress assembly is not within the threshold of the ideal temperature for the one or more regions of the active thermal mattress assembly, the method includes activating a temperature control system disposed within the active thermal mattress assembly.

Embodiments further include a method of improving a quality of sleep of a user of an active thermal mattress assembly. The method includes monitoring, by a processor, one or more signals received from one or more sensors, wherein at least one of the one or more signals is indicative of a surface temperature the active thermal mattress assembly. The method also includes determining a sleep state of a user of the active thermal mattress assembly based on one or more of the plurality of signals and determining whether the surface temperature of the active thermal mattress assembly is within a threshold of an ideal temperature for the active thermal mattress assembly. Based on determining that the surface temperature of the active thermal mattress assembly is not within the threshold of the ideal, the method includes activating a temperature control system disposed within the active thermal mattress assembly.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features and advantages of the invention are apparent from the following detailed description taken in conjunction with the accompanying drawings in which:

FIGS. 1A and 1B respectively illustrate a top view and a cross-sectional of an active thermal mattress assembly in accordance with an exemplary embodiment;

FIG. 2 illustrates a block diagram of an active thermal mattress assembly with body sensing in accordance with an exemplary embodiment;

FIG. 3 illustrates a flow chart diagram of a method for actively controlling a thermal mattress with body sensing in accordance with an exemplary embodiment; and

FIG. 4 illustrates a flow chart diagram of a method for actively controlling a thermal mattress with body sensing based on a sleep state of a user in accordance with an exemplary embodiment.

### DETAILED DESCRIPTION

In exemplary embodiments an active thermal mattress assembly with body sensing is provided. The active thermal mattress assembly is configured to actively determine the surface temperature of the mattress in contact with the one or more individuals using the mattress. The active thermal mattress assembly also includes a temperature control system which may include a heating and/or cooling systems that can be used adjust the temperature of the mattress to maintain a comfortable environment for the users. In one embodiment, the active thermal mattress assembly includes a control system that receives temperature data from the sensors in the active thermal mattress assembly and responsively controls the operation of the cooling and heating systems to automatically maintain a comfortable environment for the users. In another embodiment, the active thermal mattress assembly includes a control system that receives various types of data from the sensors in the active thermal mattress assembly, determines a sleep state of the users of the mattress and responsively controls the operation of the cooling and heating systems based on the sleep state of the users of the mattress.

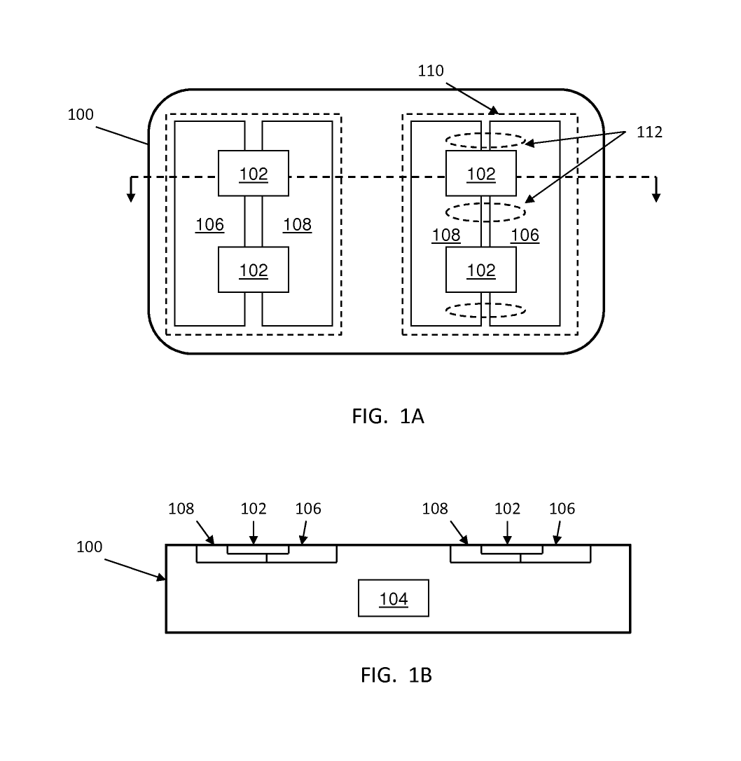

Referring now to FIGS. 1A and 1B which respectively illustrate a top view and a cross-sectional of an active thermal mattress assembly 100 with body sensing in accordance with an exemplary embodiment. In exemplary embodiments, the active thermal mattress assembly 100 includes a plurality of sensors 102, a control system 104, a heating system 106 and a cooling system 108. Although the heating system 106 and the cooling system 108 are illustrated as being separate, in various embodiments the heating system 106 and cooling system 108 may be combined into a single heating and cooling system. In exemplary embodiments, the plurality of sensors 102 may be disposed in, on, or under various locations in the active thermal mattress assembly 100.

In exemplary embodiments, the active thermal mattress assembly 100 includes both a mattress and a foundation. The plurality of sensors 102, the control system 104, the heating system 106 and/or the cooling system 108, or portions thereof, may be selectively disposed within either the mattress or the foundation. For example, in one embodiment, the mattress may include a first subset of the plurality of sensors 102 and the remaining plurality of sensors 102 may be disposed within the foundation. Likewise, in another embodiment, a first portion of the heating system 106 may be disposed within the mattress and a second portion of the heating system 106 may be disposed within the foundation.

In exemplary embodiments, the plurality of sensors 102 may include a variety of types of sensors to monitor the active thermal mattress assembly 100 and the users of the active thermal mattress assembly 100. As will be appreciated by those of ordinary skill in the art, a wide variety of various sensor technologies can be used to monitor the thermal conditions of the active thermal mattress assembly 100 and one or more vital signs of the users of the active thermal mattress assembly 100. For example, one or more of the plurality of sensors 102 may be a temperature sensor that is configured to monitor a surface temperature of a location on the active thermal mattress assembly 100. In another example, one or more of the plurality of sensors 102 may be a piezoelectric sensor that is configured to detect a heart rate, breathing or motion of a person using the active thermal mattress assembly 100.

In exemplary embodiments, each of the heating system 106 and cooling systems 108 may be associated with a particular zone of the active thermal mattress assembly 100. For example, a king or queen sized mattress may be divided into two zones 110 that have one or more sensors 102 that are associated with each zone. In addition, each of the zones 110 may have multiple sensors 102 that are used to detect the conditions at various regions 112 of the zone 110. For example, a zone 110 may include three temperature sensors 102 for detecting a head temperature, a core temperate and a foot temperature. In exemplary embodiments, a temperature sensitive material may be used to determine the current microclimate temperature in a region of the active thermal mattress assembly 100. In one embodiment, the sensors 102 may be placed in the surface fabric of the active thermal mattress assembly 100 or in bed clothes worn by the user. In exemplary embodiments, the heating system 106 and cooling systems 108 may use any of a wide variety of well-known heating and cooling technologies to heat and cool the active thermal mattress assembly 100.

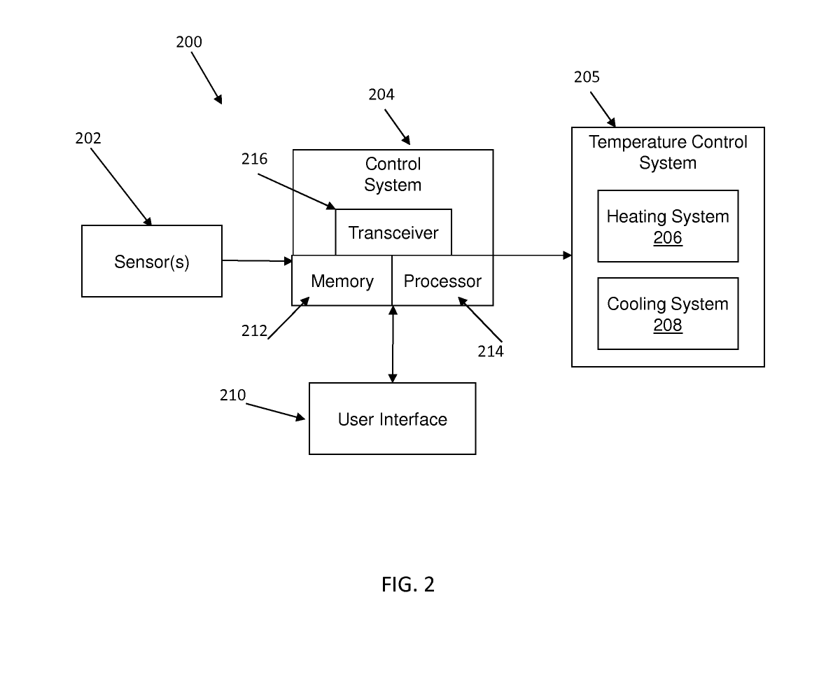

Referring now to FIG. 2, a block diagram of an active thermal mattress assembly 200 with body sensing in accordance with an exemplary embodiment is shown. In exemplary embodiments, the active thermal mattress assembly 200 includes a control system 204 which is configured to receive data from each of the plurality of sensors 202 and to responsively control the operation of a temperature control system 205. In exemplary embodiments, the temperature control system 205 may include a heating system 206 and/or a cooling system 208. The control system 204 may include a processor 214, a memory 212, and a transceiver 216. The control system 204 may communicate with the plurality of sensors 202 wirelessly or via wired connections. In exemplary embodiments, the control system 204 is configured to store the information received from the plurality of sensors 202 in the memory 212. In one embodiment, the processor 214 may be disposed within the active thermal mattress assembly 200. In other embodiments, the processor 214 may be located near the active thermal mattress assembly 200 but not be disposed within or within the active thermal mattress assembly 200.

In exemplary embodiments, the processor 214 may be a digital signal processing (DSP) circuit, a field-programmable gate array (FPGA), an application specific integrated circuits (ASICs) or the like. The processor 214 can be any custom made or commercially available processor, a central processing unit (CPU), an auxiliary processor among several processors, a semiconductor based microprocessor (in the form of a microchip or chip set), a macroprocessor, or generally any device for executing instructions.

In exemplary embodiments, the control system 204 is configured to communicate to with a user interface 210 that a user of the active thermal mattress assembly 200 can use to modify one or more settings of the control system 204. In one embodiment, the control system 204 includes a Bluetooth® or Wi-Fi transceiver 216 that is can be used to communicate with a wireless device or wireless network. In exemplary embodiments, the control system 204 is configured to connect to a web-service over a Wi-Fi connection and a user of the active thermal mattress assembly 200 can use the web-service to modify one or more settings of the control system 204 and to view data collected by the control system 204 that is stored in the memory 212.

In exemplary embodiments, the one or more settings of the control system 204 may include a desired surface temperature for each zone of the active thermal mattress assembly 200. Likewise, the one or more settings may include temperature setting for different regions within each zone. In exemplary embodiments, the one or more settings may also allow the user to specify different desired temperatures for different sleep states. In exemplary embodiments, the user interface may 210 may allow a user to view statistics gathered on the quality of their sleep and may provide suggested changes to various temperatures to help improve the quality of the user's sleep. In exemplary embodiments, the processor 214 may be configured to analyze the statistics gathered on the quality of a user's sleep and to make automatic adjustments to the various temperatures to help improve the quality of the user's sleep.

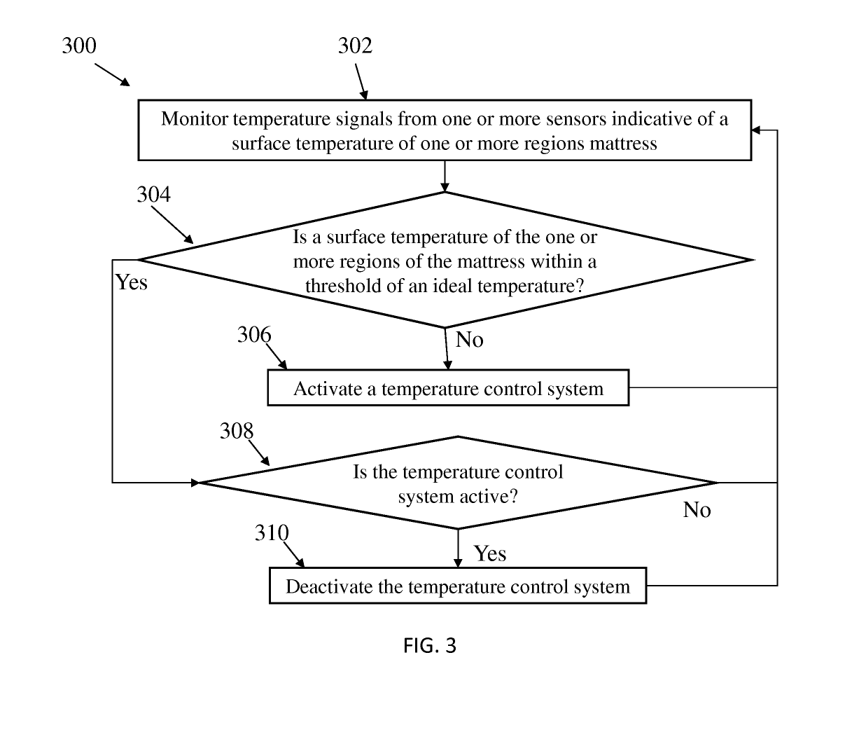

Referring now to FIG. 3, a flow chart diagram of a method 300 for actively controlling a thermal mattress with body sensing in accordance with an exemplary embodiment is shown. As shown at block 302, the method 300 includes monitoring one or more temperature signals from one or more sensors indicative of a surface temperature of one or more regions of a mattress. Next, as shown at decision block 304, the method 300 includes determining if a surface temperature of the one or more regions of the mattress is within a threshold of an ideal temperature. In exemplary embodiments, a control system of the active thermal mattress assembly can determine if a zone of a bed is occupied and based on that determination the control system may set an ideal temperature for each region of the occupied zone of the mattress. In addition, the control system may select a threshold variance that is permitted from the ideal temperature. For example, the ideal temperature may be set to 83.0 degrees Fahrenheit and the threshold variance may be 1.0 degree Fahrenheit. If a surface temperature of the one or more regions of the mattress is within a threshold of an ideal temperature, the method 300 proceeds to decision block 308. Otherwise, the method 300 proceeds to block 306 and activates a temperature control system based on the difference between the detected temperature and the ideal temperature. Once the temperature control system is activated, the surface temperature continues to be monitored, as shown at block 302. As shown at decision block 308, it is determined if the temperature control system is active. If the temperature control system is active, the temperature control system is de-activated, as shown at block 310. In exemplary embodiments, the temperature feedback allows the active thermal mattress assembly to actively maintain a comfortable temperature with respect to its occupant. Since no two occupants are identical, the system senses the surface temperature and responds accordingly rather than a one size fits all approach.

Continuing now with reference to FIG. 2, in exemplary embodiments the control system 204 may either receive from one of the plurality of sensors 202 or may determine from data received from the plurality of sensor 202, a sleep state of a user of the active thermal mattress assembly 200. By understanding changes in sleep state, and its correlation to sleep quality, the control system 204 can adjust the temperature of the mattress react to achieve improvements in sleep quality. In exemplary embodiments, the one or more sensors 202 may include sleep state sensors which may utilize a combination of algorithms developed for determining sleep state from heart rate, breathing patterns, musculoskeletal movement and brainwaves. Current sensors available for measuring these parameters include but are not limited to piezoelectric vibrational sensors, ECG, EMG, EEG and pulse oximetry.

In general, sleep can be divided into four states of sleep. Sleep stage 1 is the beginning of the sleep cycle, and is a relatively light stage of sleep. Sleep stage 2 is the second stage of sleep and lasts for approximately 20 minutes, during this the body temperature starts to decrease and the heart rate begins to decrease. Sleep stage 3 is also referred to as delta sleep because slow brain waves known as delta waves begin to emerge during this stage. Sleep stage 4 is also referred to as rapid eye movement (REM) sleep and is characterized by eye movement, increased respiration rate and increased brain activity.

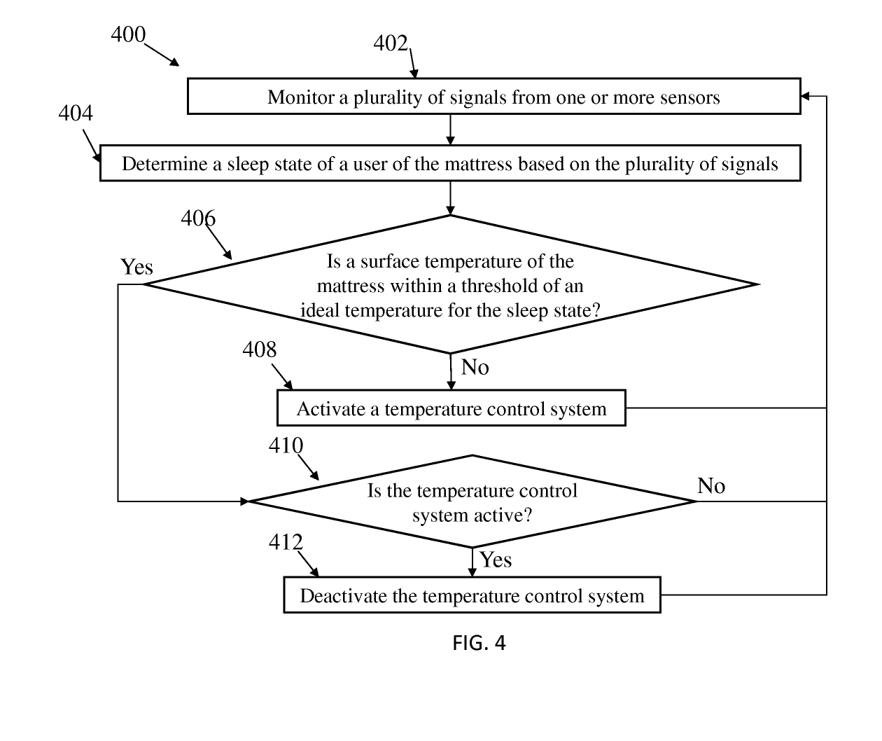

Referring now to FIG. 4, a flow chart diagram of a method 400 for actively controlling a thermal mattress with body sensing based on a sleep state of a user in accordance with an exemplary embodiment is shown. As shown at block 402, the method 400 includes monitoring one or more plurality of signals from one or more sensors. Next, as shown at decision block 304, the method 300 includes determining a sleep state of a user of the mattress based on the plurality of signals. As shown at decision block 306, the method 300 includes determining if a surface temperature of the mattress within a threshold of an ideal temperature for the sleep state. If a surface temperature of the one or more regions of the mattress is within a threshold of an ideal temperature, the method 400 proceeds to decision block 410. Otherwise, the method 400 proceeds to block 408 and activates a temperature control system based on the difference between the detected temperature and the ideal temperature. Once the temperature control system is activated, the surface temperature continues to be monitored, as shown at block 402. As shown at decision block 410, it is determined if the temperature control system is active. If the temperature control system is active, the temperature control system is de-activated, as shown at block 412. In exemplary embodiments, the temperature feedback allows the active thermal mattress assembly to actively maintain a comfortable temperature with respect to its occupant. Since no two occupants are identical, the system senses the surface temperature and responds accordingly rather than a one size fits all approach.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The components and materials described hereinafter as making up the various embodiments are intended to be illustrative and not restrictive. Many suitable components and materials that would perform the same or a similar function as the materials described herein are intended to be embraced within the scope of embodiments of the present invention. While embodiments of the present invention have been disclosed in exemplary forms, it will be apparent to those skilled in the art that many modifications, additions, and deletions can be made therein without departing from the spirit and scope of the invention and its equivalents, as set forth in the following claims.

What is claimed is:

1. An active thermal mattress assembly comprising:
a plurality of sensors disposed within the active thermal mattress assembly, wherein at least one of the plurality of sensors monitors a surface temperature of the active thermal mattress assembly ;
a temperature control system disposed within the active thermal mattress assembly; and
a processor disposed within the active thermal mattress assembly ,
wherein the processor is configured to receive signals from each of the plurality of sensors and to responsively control an operation of the temperature control system to maintain an ideal surface temperature of the active thermal mattress assembly .

2. The active thermal mattress assembly of claim 1, wherein at least one of the plurality of sensors monitors a sleep state of a person using the active thermal mattress assembly.

3. The active thermal mattress assembly of claim 2, wherein the ideal surface temperature is determined by the processor based on the sleep state of a person using the active thermal mattress assembly.

4. The active thermal mattress assembly of claim 1, wherein maintaining the ideal surface temperature of the active thermal mattress assembly includes determining if a difference between the surface temperature of the active thermal mattress assembly and the ideal surface temperature exceeds a threshold value.

5. The active thermal mattress assembly of claim 1, wherein the processor is configured to communicate with a user interface and wherein the user interface allows a user to set the ideal surface temperature.

6. The active thermal mattress assembly of claim 1, wherein the processor stores signals received from each of the plurality of sensors in a memory and automatically adjusts the ideal temperature to improve a quality of a user's sleep based on data stored in the memory.

7. The active thermal mattress assembly of claim 1, wherein the active thermal mattress assembly includes two zones and wherein a first subset of the plurality of sensors is configured to monitor the surface temperature of a first zone and a second subset of the plurality of sensors is configured to monitor the surface temperature of a second zone.

8. The active thermal mattress assembly of claim 1, wherein the active thermal mattress assembly includes a foundation and a mattress.

9. A method of improving a quality of sleep of a user of an active thermal mattress assembly comprises:
monitoring, by a processor, one or more temperature signals received from one or more sensors indicative of a surface temperature of one or more regions of the active thermal mattress assembly;
determining whether the surface temperature of the one or more regions of the active thermal mattress assembly are within a threshold of an ideal temperature for the one or more regions of the active thermal mattress assembly;
based on determining that the surface temperature of at least one of the one or more regions of the active thermal mattress assembly is not within the threshold of the ideal temperature for the one or more regions of the active thermal mattress assembly, activating a temperature control system disposed within the active thermal mattress assembly.

10. The method of claim 9, further comprising:
based on determining that the surface temperature of all of the one or more regions of the active thermal mattress assembly is within the threshold of the ideal temperature for the one or more regions of the active thermal mattress assembly, deactivating the temperature control system.

11. The method of claim 9, wherein the ideal surface temperature for the one or more regions of the active thermal mattress assembly is received from the user of the active thermal mattress assembly through a user interface configured to communicate with a processor in the active thermal mattress assembly.

12. The method of claim 9, further comprising storing signals received from each of the plurality of sensors in a memory and automatically adjusting the ideal temperature to improve a quality of a user's sleep based on data stored in the memory.

13. A method of improving a quality of sleep of a user of an active thermal mattress assembly comprises:
monitoring, by a processor, one or more signals received from one or more sensors, wherein at least one of the one or more signals is indicative of a surface temperature the active thermal mattress assembly;
determining a sleep state of a user of the active thermal mattress assembly based on one or more of the plurality of signals;
determining whether the surface temperature of the active thermal mattress assembly is within a threshold of an ideal temperature for the active thermal mattress assembly;
based on determining that the surface temperature of the active thermal mattress assembly is not within the threshold of the ideal, activating a temperature control system disposed within the active thermal mattress assembly.

14. The method of claim 13, further comprising:
based on determining that the surface temperature of the active thermal mattress assembly is within the threshold of the ideal temperature, deactivating the temperature control system.

15. The method of claim 13, wherein the ideal surface temperature for the active thermal mattress assembly is received from the user of the active thermal mattress assembly through a user interface configured to communicate with a processor in the active thermal mattress assembly.

16. The method of claim 13, further comprising storing signals received from each of the plurality of sensors in a memory and automatically adjusting the ideal temperature to improve a quality of a user's sleep based on data stored in the memory.

17. The method of claim 13, wherein the active thermal mattress assembly includes a foundation and a mattress.
